(19) United States
(12) Patent Application Publication
(10) Pub. No.: US 2007/0174093 A1
(43) Pub. Date: Jul. 26, 2007

(54) Method and system for secure and protected electronic patient tracking

(76) Inventors: Dave Colwell, Pewaukee, WI (US); Chris Felton, Menomonee Falls, WI (US); Patrick Greischar, Whitefish Bay, WI (US); Ross Greinke, Mequon, WI (US); Robert Hedgcock, Oconomowoc, WI (US)

Correspondence Address: TRIANGLE PATENTS, P.L.L.C., P.O. BOX 28539, RALEIGH, NC, 27611-8539, US

(21) Appl. No.: 11/728,357

(22) Filed: Mar. 26, 2007

Related U.S. Application Data
(63) Continuation-in-part of application No. 11/226,875, filed on Sep. 14, 2005.

(51) Int. Cl. G06F 19/00; G06F 17/30

(52) U.S. Cl. 705/3; 707/9

(57) ABSTRACT

The present invention provides a method and a system for tracking patients during a medical emergency or in a medical facility. The present invention provides for recording patient data, assigning the patient to a medical facility or resource and updating patient tracking information with this information. Further, the medical facility or resource that the patient is assigned to is provided with permissions to access the patient's medical records. The medical facility or resource also receives an alert informing the facility or resource about the incoming patient. Further, the present invention provides storing patient tracking information and patient medical information in a way such that users accessing the patient information are provided information based on their access level that is determined dynamically.

### CROSS REFERENCE TO RELATED APPLICATION

This application is a continuation in part of application “Electronic Data Management System for Emergency First-Responders and Method of Use”, filed Sep. 14, 2005, application Ser. No. 11/226,875, the text of which is incorporated herein by reference in its entirety.

### BACKGROUND OF THE INVENTION

1. Field of the Invention

The present invention relates generally to a patient tracking system for use by medical personnel. Additionally, the present invention relates to a computer implemented system and method for medical personnel and, more particularly, for medical emergency personnel to collect, organize and communicate patient information, as well as identify, tag, transport, and track patients to a receiving medical facility. Further, this invention pertains to a medical record management system which may be accessed at a mass-crisis scene or a medical facility and a method for tracking patient information and updating patient records in real-time.

2. Description of the Prior Art

A multiple-victim disaster can overwhelm ill-prepared medical facilities. It puts pressure on the existing facilities. Medical personnel are required to reach the site of the emergency and take control. They should be able to collect information from the people affected by the disaster and quickly diagnose their condition for effective treatment. Additionally, they should be able to view available resources that are equipped for treating patients and assign the patients to these resources.

Another problem that is encountered during multiple-victim disasters is that of tracking the victims. Often, victims are transported to medical facilities in various regions that are not in the vicinity of the disaster. Hence, the family members of the victims are not able to locate the victims. In certain cases, multiple family members are affected by the disaster and are treated in different medical facilities. It is even more difficult to track the various family members in this case.

Yet another problem with such emergencies is the protection and privacy of patient medical records. Usually, medical information is requested at the site of the emergency and may be transmitted to a medical care facility to which the patient is transferred. In such a scenario, a number of people may have access to the medical records of the patients. This is not desirable and there are several government acts and standards that are directed to end this practice. The Health Insurance Portability and Accountability Act (HIPAA) of 1996 is one such measure to protect access to the medical records of patients.

Known prior art describes some form of emergency response supervision and tracking system after a mass casualty incident through triaging and tagging of victims with visual or machine-readable tags that record the person's identification, medical data, and other temporal/location information. Specifically, U.S. Pat. No. 6,499,658 (Goetz, et al.) and U.S. Pat. No. 6,305,605 (Goetz, et al.) describe the ability to sort patient/victims based on the urgency of their condition and transmit the information to a receiving medical facility prior to arrival. Each of these references comprised some form of emergency response supervision and tracking system after a mass casualty incident through triaging and tagging of victims with machine-readable tags that store the person's identification, medical data, and other temporal/location information.

From the above discussion it is clear that there is a need for a solution that will track patients in an emergency and provide real time status about the location of the patients. The solution should also be able to protect the medical records of the patients and allow access to protected medical information to certified users. Additionally, the system should be able to provide access to non protected parts of medical records to personnel to aid in tracking of the patients and to allow emergency personnel to provide real time information about the patients to their relatives.

Further, the solution should preferably interface with other operational systems, such as the Computer-Aided Dispatch (CAD), the Public Health Alerting Network (HAN), Crisis Incident Management Systems (CIMS) or other standards that are known in the art. This broad range of communication options enables medical personnel to best coordinate patient treatment in a crisis situation.

Communication of patient information and transportation of patients, particularly after a mass casualty disaster, between emergency first-responders and medical facilities is critical. Thus, there is a need for a method for identifying a patient, recalling medical history, relating triage information, detailing current medical status, organizing transport to a designated medical facility, and tracking and updating a patient's records in real-time in a secure and protected way.

### SUMMARY OF THE INVENTION

It is objective of the present invention to provide a method and a system for tracking patients and providing patient information.

It is another objective of the present invention to provide secure access to patient tracking information.

It is still another objective of the present invention to store patient tracking information and patient medical information in a way such that users accessing the patient information are provided information based on their access role that is determined dynamically.

It is still another objective of the present invention to provide access to the patient medical information to one or more medical facilities selected to treat the patient.

It is yet another objective of the present invention to provide alerts to medical facilities about incoming patients.

The present invention is directed to a data management system for tracking patient information and providing medical facilities with access to medical information of patients that are assigned to those medical facilities. The present invention is operable at site of a medical emergency to allow emergency first responders to record patient information and direct patients to multiple medical facilities. The system also allows tracking casualties of the medical emergency by recording tracking information related to the casualties in the system. This information is accessible to authorized users to provide to relatives of the casualties.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic view of the overall system in accordance with an embodiment of the present invention.

FIG. 2 is a schematic representation of the patient information database, in accordance with an embodiment of the present invention.

FIG. 3 is a flowchart showing the steps involved in tracking patients and providing patient information, in accordance with an embodiment of the present invention.

FIG. 4 is a flowchart depicting the steps of providing patient tracking information to a user, in accordance with an embodiment of the present invention.

FIG. 5 is a flowchart depicting the steps of modifying patient tracking information by a user, in accordance with an embodiment of the present invention.

FIG. 6 is a flowchart depicting the steps of providing patient medical information to a user, in accordance with an embodiment of the present invention.

FIG. 7 is a flowchart depicting the steps of modifying patient medical information by a user, in accordance with an embodiment of the present invention.

### DETAILED DESCRIPTION OF THE PREFERRED EMBODIMENTS

The present invention provides a patient tracking system for providing medical facilities and medical service providers access to patient medical data and for providing emergency service providers information about patient tracking information. The present invention is adapted to work in medical facilities such as hospitals, clinics, and the like as well as at site of medical emergencies that involve multiple victims in one or more locations, such as natural disasters and the like.

The present invention provides a system and a method for recording patient information at the site of the medical emergency or at a medical facility. At the site of a medical emergency, a user records patient information such as symptoms or injuries. This information is recorded such that only authorized users have access for viewing or modifying this information. Then the patient is assigned to a medical facility to be treated. This information is also entered in the system to aid in tracking the patient. In one embodiment, the medical facility to which the patient is assigned to is automatically granted access rights to the patient's medical information so that authorized personnel in the medical facility are able to access the medical information in order to treat the patient. This is done automatically on the basis of the patient being transferred to the specified medical facility. The patient tracking information is also protected so that only users with access to this information can view or modify it. Hence, users at the medical facility are able to view and modify patient medical information and a second set of users are able to provide tracking information about the patient without being able to view or modify the patient medical information.

In an embodiment of the present invention, patient information is divided into two main categories, patient medical information and patient tracking information. There may be other classifications of patient information possible without deviating from the scope of the present invention. The information is classified in such a way so that medical information and tracking information is stored so that access to these information categories can be controlled on the basis of the user accessing the information. However, in certain cases it is desirable to provide a user with access to both types of information. The present invention also provides for accessing the patient medical information and the patient tracking information simultaneously by a single user. The patient medical information essentially comprises information relating to health of a patient such as past medical conditions and medications, current conditions and medications, allergies, and the like. It also includes health insurance information, Medicare information and other information that may be related to the health and medical conditions of the patient. Patient tracking information includes information that is useful in identifying the location of a patient such as current location, destination of a patient being transferred, current medical facility, current location within a medical facility, if patient is being transferred then estimated time of arrival at a medical facility or a location within a medical facility, estimated time of stay within a medical facility and the like. Also stored is patient personal information such as, name, age, gender, address. These fields are physically stored as one record in a database system but are separated at a logical level to illustrate the differentiation of the categories at a logical level. The patient information categories can comprise other fields and the separation of fields into categories can be dynamic rather than predetermined.

When a user requests access to information for a given patient, the system checks to see if that user has access to the information requested. In one embodiment of the present invention, the system also stores an access role that a user has to the specified patient information. A user can have read-only access to patient information, or can have read-write access to the information. The role of access by a user to the patient's information is determined by an access control module. This module determines granting or denying access to the requested patient information, medical and/or tracking, on the basis of the one or more fields of information associated with the user requesting access. For example, a list of users along with their access rights is maintained. The access control module reads the access right for the user accessing information and on that basis permits/rejects access to that information. The access rights can also be determined from a combination of fields, such as associated medical facility. In case user's medical facility is the same as the one to which the patient is being assigned and the users rank (designation), a field stored for users in the list of users, is in a list of permitted designations then the user can be granted access to the patient's medical information. The access control module, in this case, maintains a list of user designations that can access patient information. The designation may also be used to determine the level of access to the patient information. An administrator can setup the list of user designations and their access level. The access control module then queries against this list to determine the level of access to be granted to a user with a designation matching one present in the list.

In another scenario, if the user belongs to a medical aid agency such as WHO or Red Cross, then access to the patient's tracking information can be provided. In another embodiment, a user list specifying users, their access role and information that they can access is stored for each patient stored in the system. In yet another embodiment, there is a list of users specifying their access role and information that they can access for a group of patients or for all patients that are stored in the system.

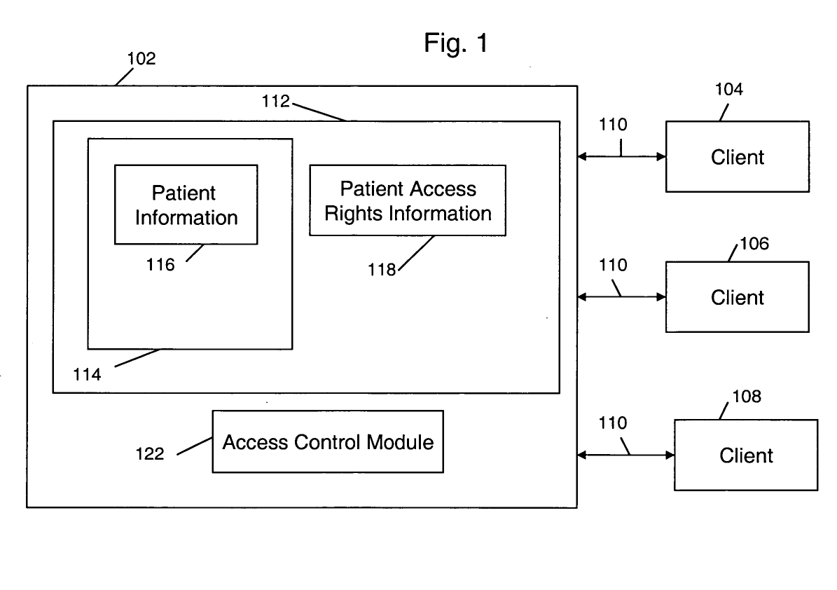

Referring now to the drawings in general, the illustrations are for the purpose of describing a preferred embodiment of the invention and are not intended to limit the invention thereto. FIG. 1 is a schematic view of the overall system in accordance with an embodiment of the present invention. Server 102 is connected to multiple clients 104, 106 and 108 via network 110. Server 102 may be any personal computer having one or more processing means, storage means and memory means, as commonly known in the art. Clients 104, 106 and 108 can be personal computers, server computer, laptop computers, tablet PCs, mobile phones and other devices known in the art capable of accessing a website or webpage or running a standalone or client application. Clients 104, 106 and 108 can also be computing devices that can access server 102 through a visual user interface or programmatic interface. Clients 104, 106 and 108 access server 102 via network 110. Network 110 can be a local intranet, the internet, and the means of access the server 102 may be wired, wireless or via a mobile network.

Server 102 has patient database 112 residing on it. Patient database 112 is a database having means for storing data and organizing data into tables. Commercial examples of databases that can be used to provide patient database 112 include Microsoft® SQL Server and Oracle®. In another embodiment of the present invention, patient database 112 is separate from server 102. Patient database 112 is stored on a second server that is connected to server 102 by means commonly known in the art.

Patient database 112 stores patient record 114 for one or more patients. Patient record 114 further comprises patient information 116. Patient information 116 includes information about the patient such as name, address, age, gender, medical condition, diseases, allergies, preferred physician, patient locational information, triage category, special needs (diabetic, etc), emergency contact/relative, belongings/personal property, special identification marks, picture, and the like. Patient database 1.12 further stores patient access rights information 118. This is used to determine if users can access patient information 116. In one embodiment of the present invention, patient access rights information 118 stores a list of users that can access patient information 116 for one or more patients. Patient access rights information 118 also stores access rights of the users that have access to patient information 116. It also stores additional fields of information that may be required to determine the level of access the users have to patient information 116. These can include medical facility or organization that the user is associated with, the user's designation, role, to name a few. In an alternate embodiment of the present invention, patient access rights information 118 is not stored on patient database 112, but on a different database that can communicate with patient database 112 and with clients 104, 106 and 108.

Server 102 further comprises access control module 122. Access control module screens clients 104, 106 and 108 that access server 102 and provides access to patient information 116 on the basis of the patient access rights information 118. When a client requests to view patient information, access control module 122 first determines if client has access to patient information by matching client information with patient access rights information 118. In another embodiment of the present invention, access control module 122 is not part of server 102, but is part of another server that can communicate with server 102 by means known in the art.

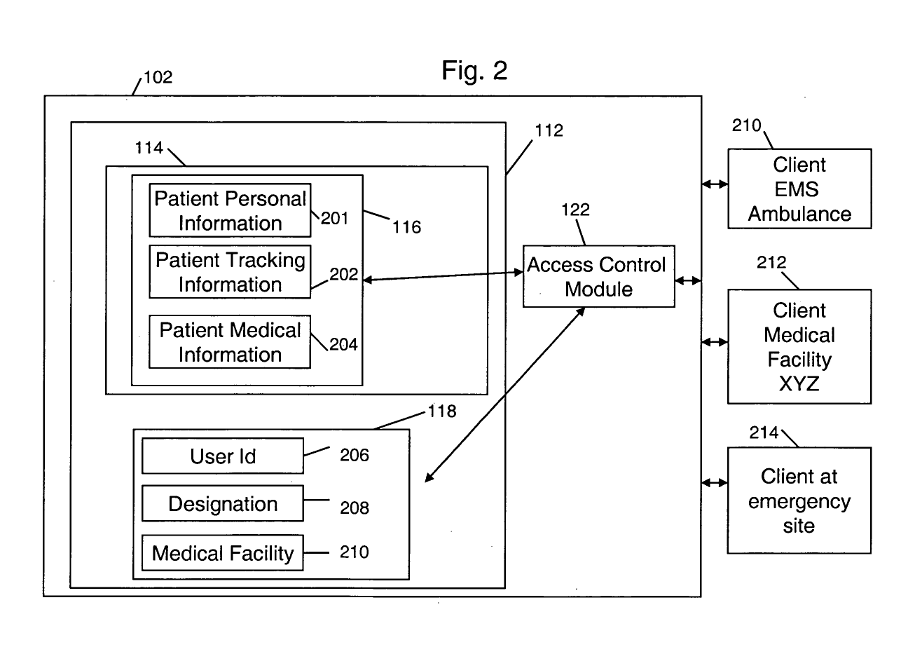

FIG. 2 is a schematic representation of the patient information database, in accordance with an embodiment of the present invention. Patient information 116 is shown as three patient information categories, patient personal information category 201, patient tracking information category 202 and patient medical information category 204. Patient personal information category 201 comprises information fields such as name, age, gender, address and the like. Patient tracking information category 202 comprises information fields such as current location, destination of a patient being transferred, current medical facility, current location within a medical facility, if patient is being transferred then estimated time of arrival at a medical facility or a location within a medical facility, estimated time of stay within a medical facility, current treatment status, patient personal belongings, location of those belongings, patient relatives, location of patient relatives and the like. This information is useful in identifying the present or future physical location of a given patient. Patient medical information category 204 comprises information fields relating to the medical history of the patient. This includes health record of the patient, past diseases and treatments, medical insurance details, and the like. In one embodiment of the present invention, the personal information 201, tracking information 202 and the medical information 204 are stored as one record. The distinction is made for clearly identifying the three different types of information categories contained in medical record 114 of a patient. For the sake of illustration, three information categories have been explained here. The number of information categories is not limited to three as illustrated above. Additionally, each information category can have fields as low as one.

For the sake of conciseness, other distinctions of the information contained in a medical record of a patient are not elaborated but are within the scope of the invention, as will be apparent to one skilled in the art. In an embodiment of the present invention, patient personal information 201 is viewable by all users in the system. In another embodiment of the present invention, users that have access to either patient tracking information 202 or to patient medical information 204 also have access to patient personal information 201 for the specific patient.

Patient access rights information 118 includes user id 206, designation 208 and medical facility 210. User id 206 is unique for each user of the system and identifies the user. Designation 208 specifies the user's designation or authority level. This can be stored as the user's job title or the user's role, i.e., if the user is a simple user, an administrator, system administrator, a guest user, or the like. Medical facility 210 specifies the facility with which the user is associated with. When a user requests access to certain information categories and fields within those categories for a specific user, access control module 122 determines if the user has access to the requested information categories on the basis of patient access rights information 118.

The system of the present invention is implemented in a variety of medical facilities and other related facilities in a number of regions spread over a geography. Each region can specify an administrator that can manage users having access to the information stored in the system. The administrators also manage users that can input the medical and tracking information. User rights are managed by regional administrators. Regional administrators can specify rights for each individual user. An individual right allows the user to view and/or update subsets of data or information fields within the information category for patients within specified medical divisions. The patients are initially assigned to a medical facility. The medical facility is part of a hierarchy of facilities within a given region or geography. Medical facilities from different regions can also be a part of a common hierarchy. Medical facilities that belong to the same hierarchy (as parent or children, directly or indirectly) can be provided access to information fields of patients assigned to other facilities but within the same division/hierarchy. A user with a given right in a given division hierarchy will have access to zero or more patients who share a common association within the division hierarchy.

A patient's medical and tracking information is captured by users and associated with divisions to which the user has rights allow a user to associate a patient's information with other divisions as defined in the division hierarchy. This mechanism allows for the managed real-time participation of users within multiple associated divisions.

For example, consider client 210 that is an Emergency Medical Services Ambulance. Client 210 should be able to make changes to patient medical information 204 and also to patient tracking information 202. These changes include initial diagnosis of the patient's symptoms en route to a medical facility XYZ and estimated time of arrival at the medical facility. Client 210 also needs access to patient medical information 204 to determine, for example, if the patient has any side affects to medication that the patient may require en route to the medical facility. Hence, all users of type field medical emergency personnel as their designation and associated with medical facilities or emergency operators will be granted read-write access to patient personal information category 201, patient tracking information category 202 and patient medical information category 204.

Client 212 that is a medical care provider at medical facility XYZ needs read-only access to patient tracking information 202 to determine information about the arrival of the patient. Client 212 also needs read-write access to patient medical information 204 to add information relating to the current visit, such as symptoms, treatment provided and response to the treatment. Hence, personnel associated with a medical facility that the patient is assigned to will be granted read-write access to patient medical information category 204 but read-only access to patient tracking information category 202. However, based on user designation, some users of the facility can be granted read-write access rights to patient tracking information category 202 and/or read only access rights to 204.

In an embodiment, client 214 that is a user, such as belonging to the red cross, providing information about the location of a patient to other users requesting such information, such as relatives of the patient, needs access to the patient's tracking information 202. In this case, the client 214 is provided read-only access to the patient tracking information 202 and no access to patient medical information 204. In other embodiments of the present invention, clients 210, 212, 214 can be a variety of medical facilities, public family reunification organizations, emergency operations center organizations and others.

As discussed above and will be apparent to one skilled in the art, access control module 122 determines the access role a user is granted with at the time the user requests access to one or more fields within patient information categories 201, 202 and 204. The access control module 122 gathers information from patient access rights module 118 as well as reads information from one or more categories 201, 202 and 204 to dynamically determine whether or not to grant the request for access. This is carried out dynamically on the basis of certain rules that are stored in access control module 122 or some rules that are stored such that they can be access by the module 122. In one embodiment, these rules are specified as conditions that are either built in or can be modified by some users, for example, system administrators. In other embodiments, these rules are defined by the system administrator on the basis of the region of the users, the medical facility and the system overall.

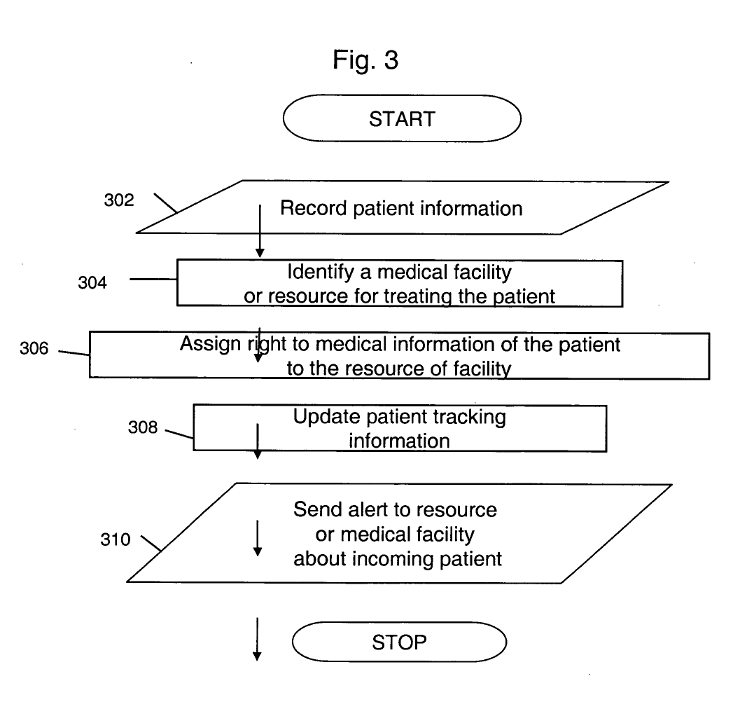

FIG. 3 is a flowchart showing the steps involved in tracking patients and providing patient information, in accordance with an embodiment of the present invention. First, patient information 116 is recorded at step 302. In one embodiment of the present invention, this information is recorded at a medical facility and may relate to the patient's visit to the medical facility. In another embodiment, this information is recorded at a site of a medical emergency such as a natural disaster. This information relates to the patient's injuries or other medical conditions that may or may not arise due to the medical emergency. This information is stored in the system by a user of the system who has sufficient rights to enter information in the system. At step 304, the user identifies a medical facility or a resource for treating the patient. In case of a medical emergency, the user identifies a medical facility that is equipped to handle the patient's specific needs. In another embodiment, the user identifies the medical facility or resource on the basis of medical resource availability information that is provided to the user. The system then assigns the identified medical resource or facility access rights to the medical information 204 of the patient, at step 306. The patient tracking information 202 is then updated to reflect the assignment of the patient to the identified medical resource or facility, at step 308. The user updates this information to reflect the new location of the patient. In another embodiment, the user also provides information such as estimated time of arrival of the patient at the identified medical resource or facility. At step 310, an alert is generated and sent to the identified medical resource or facility or a user that is associated with the medical resource or facility. The purpose of this is to alert the medical facility or resource about the assignment of the patient to that facility or resource so that the medical facility or resource can prepare to receive the patient. Alternatively, the alert is sent to inform the medical facility or resource or a user associated with the medical facility or resource about access to the medical information 204 of the incoming patient. During the course of the transfer of the patient to the medical facility or after the patient has been transferred to the first identified medical facility, the patient can be reassigned to another medical facility. This information is then entered in to the system. On the basis of this change, the second medical facility would be granted access to the patient's information.

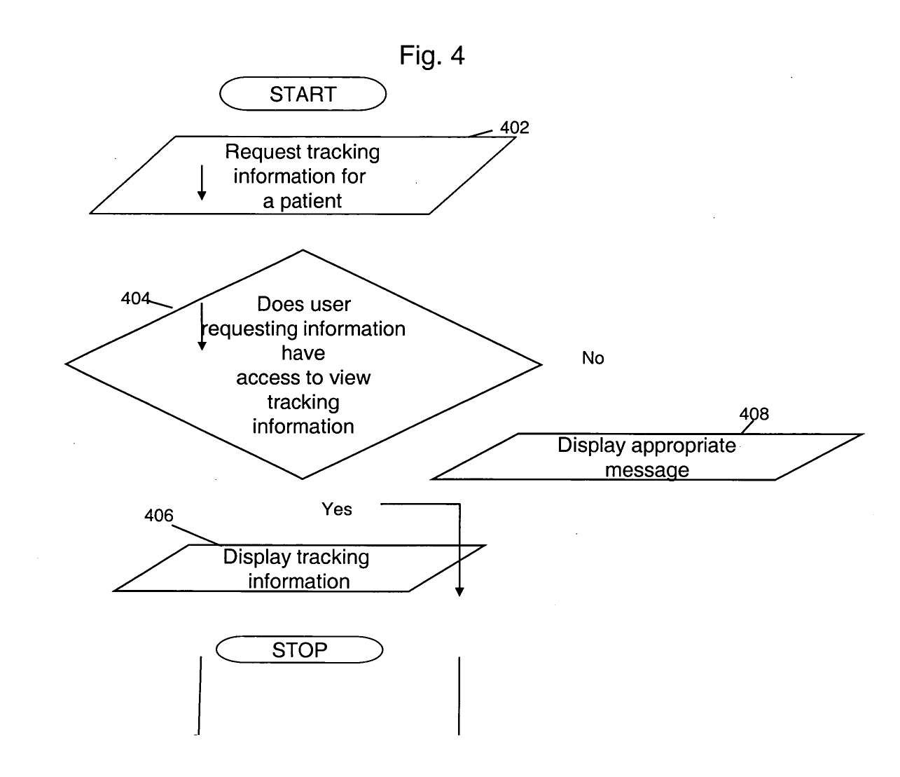

FIG. 4 is a flowchart depicting the steps of providing patient tracking information to a user, in accordance with an embodiment of the present invention. A user that needs to view the patient tracking information 202 sends a request for the same to patient database 112, at step 402. The access control module 122 determines if the user requesting the view the patient tracking information 202 has access rights to view the tracking information 202 for the patient, at step 404. In an embodiment, access control module 122 determines this by looking at patient access rights information 118 to determine if the user 206 is present in patient access rights information 118 and on the basis of designation 208 and medical facility 210 has access has rights to access patient information. For this case, user 206 should be present in patient access rights information 118. If the user has the desired access role and access rights, then the tracking information 202 is displayed to the user at step 406. If the user does not have the access rights and access role, then a message is displayed informing the user about the problem, at step 408.

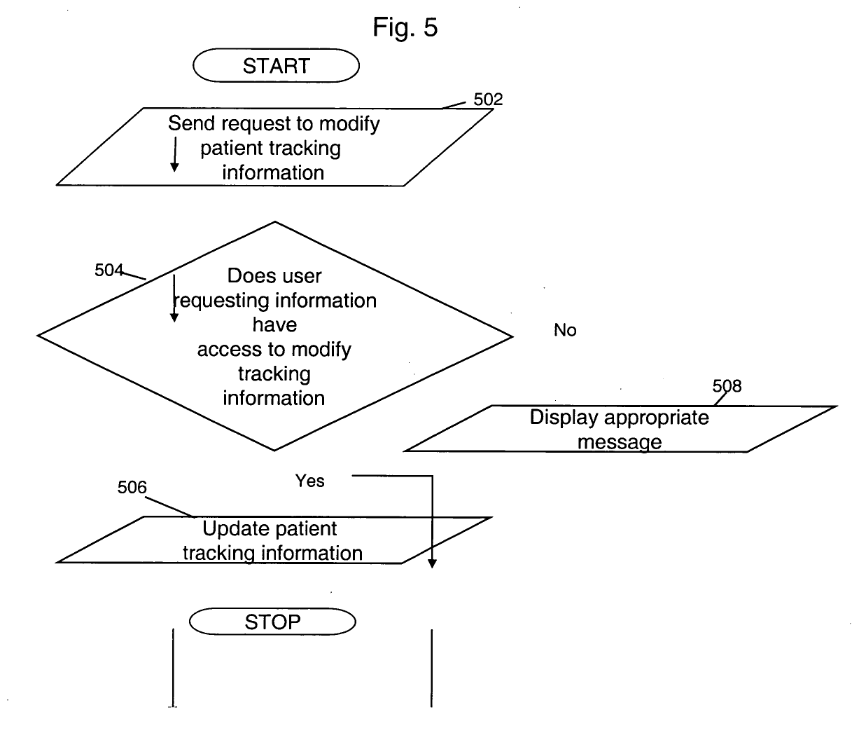

FIG. 5 is a flowchart depicting the steps of modifying patient tracking information by a user, in accordance with an embodiment of the present invention. A user that needs to modify the patient tracking information 202 sends a request for the same to patient database 112, at step 502. The access control module 122 determines if the user requesting to modify the patient tracking information 202 has access rights to modify the tracking information 202 for the patient, at step 504. In an embodiment, access control module 122 determines this by looking at patient access rights information 118 to determine if the user 206 is present in patient access rights information 118 and has sufficient access rights. If the user has the desired access role and access rights, then the tracking information 202 is updated in patient information 116 at step 506. If the user does not have the access rights and access role, then a message is displayed informing the user about the problem, at step 508.

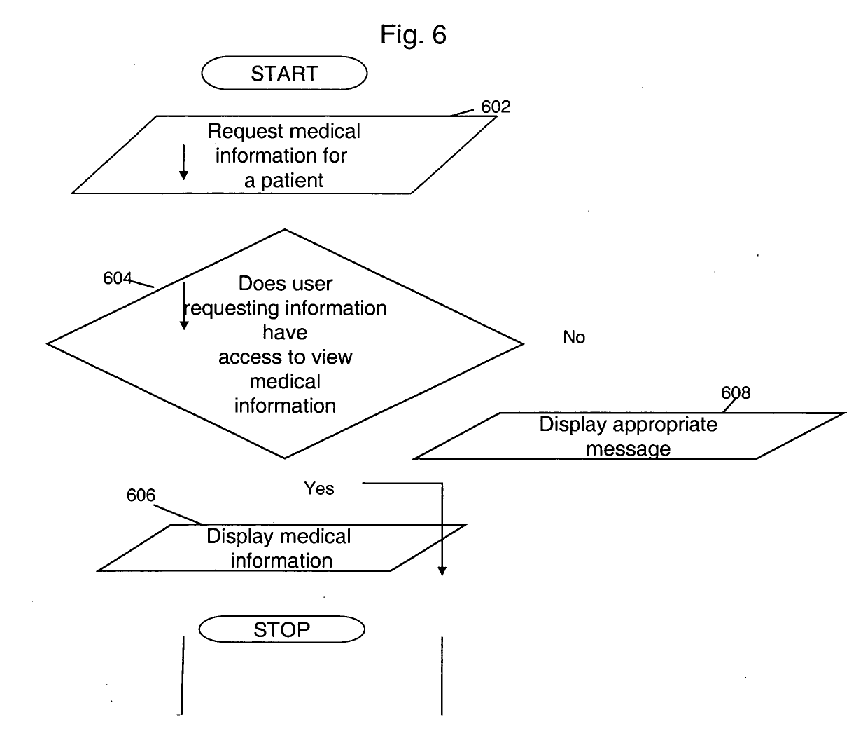

FIG. 6 is a flowchart depicting the steps of providing patient medical information to a user, in accordance with an embodiment of the present invention. A user that needs to view the patient medical information 204 sends a request for the same to patient database 112, at step 602. The access control module 122 determines if the user requesting the view the patient medical information 204 has access rights to view the medical information 204 for the patient, at step 604. In an embodiment, access control module 122 determines this by looking at patient access rights information 118 to determine if the user 206 is present in patient access rights information 118 and has sufficient access rights. If the user has the desired access role and access rights, then the medical information 204 is displayed to the user at step 606. If the user does not have the access rights and access role, then a message is displayed informing the user about the problem, at step 608.

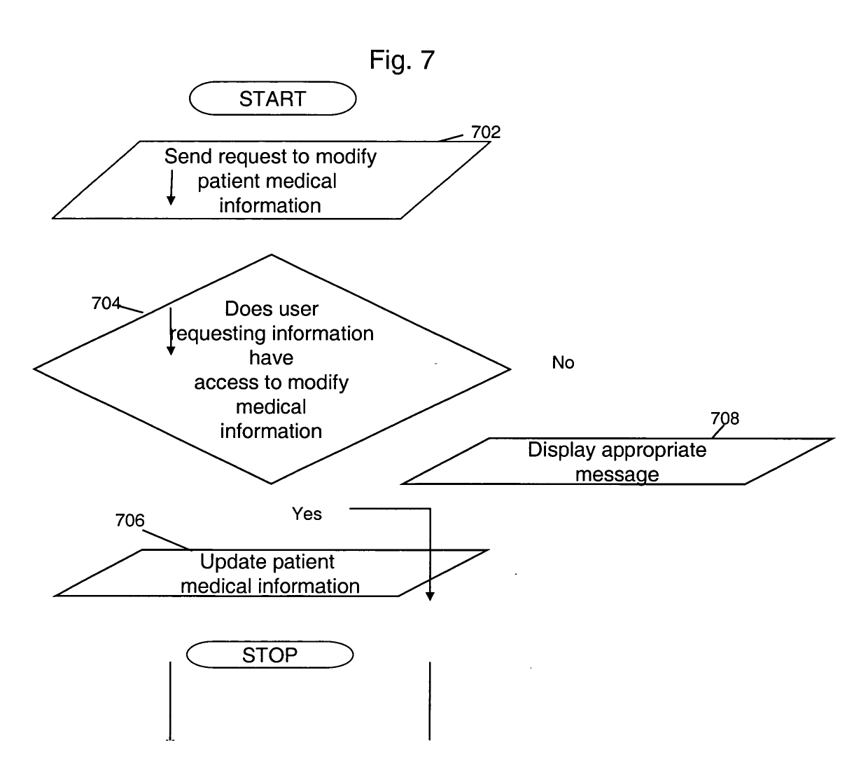

FIG. 7 is a flowchart depicting the steps of modifying patient medical information by a user, in accordance with an embodiment of the present invention. A user that needs to modify the patient medical information 204 sends a request for the same to patient database 112, at step 702. The access control module 122 determines if the user requesting to modify the patient medical information 204 has access rights to modify the medical information 204 for the patient, at step 704. In an embodiment, access control module 122 determines this by looking at patient access rights information 118 to determine if the user 206 is present in patient access rights information 118 and has sufficient access rights. If the user has the desired access role and access rights, then the medical information 204 is updated in patient information 116 at step 706. If the user does not have the access rights and access role, then a message is displayed informing the user about the problem, at step 708.

Certain modifications and improvements will occur to those skilled in the art upon a reading of the foregoing description. For example, the present invention may provide for health alert messaging. Also, the resource management system is operable for use by first-alert responders to a medical crisis scene for coordinating patient-related data with resource-related data for optimizing system utilization and for making decisions regarding directing and transporting patients to suitable medical facilities having capabilities and capacity for treating each patient, wherein the system provides for use “on-site” of a disaster, accident, or location of a patient or at a medical facility.

All modifications and improvements have been deleted herein for the sake of conciseness and readability but are properly within the scope of the following claims.

What is claimed is:

1. A method for tracking patients and providing controlled access to patient information, the method comprising the steps of:
a. recording patient information associated with a patient, the patient information comprising at least two information categories with each information category comprising at least one information field,
b. identifying at least one medical facility suitable to treat the patient,
c. adding patient tracking information to any one of the at least two information categories,
d. receiving a request from a user for access to at least one of the information fields within the categories, and
e. granting the request for access to the information fields on the basis of the user having sufficient access privileges to the information fields.

2. The method of claim 1, wherein the tracking information is selected from the group consisting locational information such as current location, destination, provider, estimated time of arrival, current treatment status, and combinations thereof.

3. The method of claim 1, further comprising the step of providing tracking information of at least one patient to at least one user, the at least one user having sufficient access privileges to the tracking information of the at least one patient.

4. The method of claim 1, further comprising the step of sending an indication to the identified medical facility about the patient being assigned to the facility.

5. The method of claim 1, wherein the user can modify the information fields including the patient tracking information.

6. The method of claim 1, further comprising the step of updating the tracking information based on changes to location information of the patient, the locational information selected from a group comprising of destination, provider, estimated time of arrival, current treatment status, and combinations thereof.

7. The method of claim 1, wherein the step of granting the user request is based on user identification, user access role and user access rights at the time of the request.

8. The method of claim 7, wherein the user access rights are determined by at least one information field.

9. The method of claim 8, wherein the information field is part of a division hierarchy.

10. The method of claim 7, wherein the user access rights are dynamically modifiable.

11. The method of claim 10, wherein the user access rights are modifiable by an access control module.

12. The method of claim 7, wherein the user access rights are modifiable by an administrator.

13. The method of claim 12, wherein the administrator is a regional administrator.

14. A system for tracking patients and providing patient information, the system comprising:
a. at least one database for storing at least two patient information categories with each patient information category having patient information fields,
b. access rights control module for determining and controlling access to the patient information fields,
c. at least one terminal, for accessing the patient information fields,
d. a network connecting the at least one database with the at least one terminal.

15. The system of claim 14, wherein a user having a user identification requests access to patient information fields via the at least one terminal.

16. The system of claim 15, wherein the access rights control module determines access to patient information fields on the basis of a combination of the fields requested and at least one of user identification, user role and user access rights at the time of the request.

17. The system of claim 14, further comprising at least one access rights database for storing a list of at least one user having access to patient tracking information for at least one patient.

18. The system of claim 15, wherein the access rights database stores a list of at least one user having access to patient information for at least one patient.

19. The system of claim 18, wherein the access rights control module grants access to the at least one terminal accessing patient information if a user associated with the at least one terminal is present in the list of at least one user having access to the patient information.

20. The system of claim 14, wherein the access rights control module grants access to the at least one user accessing patient information, based on at least one information attribute associated with the user and at least one patient information field.
